(19) United States
(12) Patent Application Publication
(10) Pub. No.: US 2012/0111800 A1
(43) Pub. Date: May 10, 2012

(54) METHOD AND SYSTEM FOR HARVESTING WATER, ENERGY AND BIOFUEL

(76) Inventor: Carol Ann Collins, Elkton, MD (US)

(21) Appl. No.: 13/381,161

(22) PCT Filed: Jun. 30, 2009
(86) PCT No.: PCT/US09/49246

§ 371 Date: Dec. 28, 2011

Related U.S. Application Data
(60) Provisional application No. 61/076,884, filed on Jun. 30, 2008.

(51) Int. Cl. C02F 11/00; C02F 1/44; C02F 1/30

(52) U.S. Cl. 210/748.07; 210/768; 204/158.21; 210/259; 210/188; 210/251; 210/243; 205/742

(57) ABSTRACT

A method for harvesting potable water and energy from waste that comprises the steps of collecting the waste, separating the waste into a water fraction, a solid fraction, and a gas fraction, sterilizing the water fraction, converting the solid fraction into an energy resource; and scrubbing the gas fraction.

### CROSS REFERENCE TO RELATED APPLICATIONS

This application claims priority to U.S. Provisional Application No. 61/076,884 entitled “Method and System For Harvesting Wastewater”, filed Jun. 30, 2008, the subject matter of which is incorporated by reference. This application may also relate to U.S. patent application Ser. No. 10/636,532, now abandoned, entitled Hybrid Magnetohydrodynamo (MHD) Field Sanitation Generator for Treating Wastewater, Sewages & Sludge and Recovering Potable Water, Energy and Biofuels and filed Aug. 8, 2003, the entire contents of which are incorporated herein by reference.

### BACKGROUND OF THE INVENTION

Agriculture and municipal treatment systems are very different in their approach to animal manure and human sewage treatment methods. However, both manure and sewage have an equivalent composition. Hog manure has a composition very similar to human sewage waste, and they share many properties and characteristics. Typically, the total manure or sewage content 70% to 80% is composed of water and 15% to 20% is composed of biosolids. Of the total biosolid content it is in the volatile solids that methane can be harvested. Biogas may be about 60% to 65% methane, 25% to 30% carbon dioxide and the remaining balance gases are composed of hydrogen sulfide, ammonia and other volatile organics.

Anaerobic digestion may be used in farming and livestock operations to recover biogas as an alternative source of fuel to power generators and boilers. Anaerobic digesters may be used as a wastewater treatment plant to process biosolids produced by the various species of livestock: hog, dairy, beef, equine, duck, etc. Digester gas (60% to 65%) methane is a byproduct of this process. With proper treatment, this methane can be used in an internal combustion engine to drive a generator and to make electricity for internal plant use or sell back to the utility.

Typically, anaerobic digestion may be an engineered system where biogas is released from bacteria through the process of biodegradation under anaerobic conditions. Methanogens, or methane producing bacteria, generate methane gas through the decomposition of organic materials. Raw material is loaded into the digester where the heat and anaerobic environment encourage the growth of methanogens. Inside the digester, the material divides into three distinct layers. The heavy raw manure sinks to the bottom, a watery layer containing the liquid effluent and bacteria sits in the middle and a layer of scum forms over the top.

Agitation may be used to prevent the formation of the scum layer. The scum layer may inhibit fermentation and to avoid differences in temperature within the digester, to mix in fresh materials, and to encourage a uniform bacterial density. Rapid agitation should be avoided as it can lead to the disruption of bacterial communities. Agitation is also helpful to ensure even temperature without “hot spot” within the digester. Temperature is a very important factor in the success of biogas digesters. The minimum average substrate temperature is between 20 and 28 degrees Celsius to be economically desirable. Typically a biogas plant uses a packaged generation system that includes an engine, generator, gas treatment system and heat recovery system. Biogas potential can be calculated according to the amount of raw manure. For example, approximately 1 kg pig dung is equivalent to 60 liters of biogas or 30 liters of biogas per day per kg weight.

The costs of establishing and running a methane digester may be dependent upon the specific type and size of the digester. Hog manure has an optimal retention time of 15-25 days to maintain fermentation bacteria at an adequate level. The capacity required of a hog operation digester therefore, is approximately 15 times the daily volume of manure. The average daily amount of manure produced differs by animal at different life stages. Each species of animal whether it be dairy cow, beef cow, chicken, horse, or duck varies. Each animal species anaerobic digester will be different one from the other. There is no generic digester that can handle every kind of manure including human sewage.

Agricultural waters may include runoff from any fanning operation, livestock operation, or other storm water runoffs including agricultural wastes. Contaminants in municipal wastewater may be introduced as a result of water usage for domestic, commercial or institutional purposes. Two main sources of water pollutants are point source and non-point source. Non-point pollutants are substances introduced into receiving waters as a result of urban area, industrial area or rural runoff; e.g. sediment and pesticides or nitrates entering surface waters due to wastewater discharge from agricultural farms. Point sources are specific discharges from municipalities or industrial complexes: e.g., organic or metals entering surface water due to wastewater discharge from a manufacturing plant. In a surface water body, non-point pollution can contribute significantly to total pollutant loading, particularly with regard to nutrients and pesticides. Municipal and industrial wastewater discharges are primary contributors to point source discharges.

Wastewater quality can be defined in terms of physical, chemical, and biological characteristics. Pathogenic organisms in wastewater can be categorized as bacteria, viruses, protozoa and helminthes. Because of the many types of pathogenic organisms and the associated measurement difficulties, coliform organisms are frequently used as indicators of human pollution. On a daily basis, each person discharges from 100 to 400 billion coliform organisms, in addition to other kinds of bacteria.

### SUMMARY OF THE INVENTION

Accordingly, the present invention relates to a method for harvesting potable water and energy from waste that comprises the steps of collecting the waste, separating the waste into a water fraction, a solid fraction, and a gas fraction, sterilizing the water fraction, converting the solid fraction into an energy resource; and scrubbing the gas fraction.

The present invention also relates to a system for harvesting potable water and energy from waste that comprises an inlet for collecting the waste, at least one electrochemical chamber coupled to the inlet that receives the waste and is adapted to treat the waste in a first phase of digestion, a filtration device that is coupled to the electrochemical chamber that receives the waste and includes a least one filter for separating the waste into at least a water fraction and a solid fraction, and at least one microwave chamber that is coupled to the filtration device and receives at least one of the water fraction or the solid fraction of the waste and is adapted to treat the waste in a second phase of digestion. A conversion unit is coupled to the microwave chamber and receives the aid one of the water fraction or solid fraction of the waste and is configured to harvest at least one energy resource therefrom.

The present invention also relates to a system for harvesting potable water and energy from waste that comprises a means for collecting the waste; a means for separating at least a water fraction and a solid fraction from the waste which is downstream of the means for collecting waste; a means for harvesting fuel from the solid fraction of the waste, which downstream from the means for separating; and a means for sterilizing the water fraction of the waste which is downstream of said means for separating.

Other objects, advantages and salient features of the invention will become apparent from the following detailed description, which, taken in conjunction with the annexed drawings, discloses a preferred embodiment of the present invention.

### BRIEF DESCRIPTION OF THE DRAWINGS

FIG. 1 is a flow diagram of the process and system according to a non-limiting embodiment of the present invention;

FIG. 2 is a structural diagram of the process and system of the present invention as illustrated in FIGS. 1; and

FIG. 3 is an enlarged elevation view of a conversion unit of the system according to an aspect of the present invention.

A more complete appreciation of the invention and many of the attendant advantages thereof will be readily obtained as the same becomes better understood by reference to the following detailed description when considered in connection with the accompanying drawings.

### DESCRIPTION OF THE NON-LIMITING EMBODIMENTS

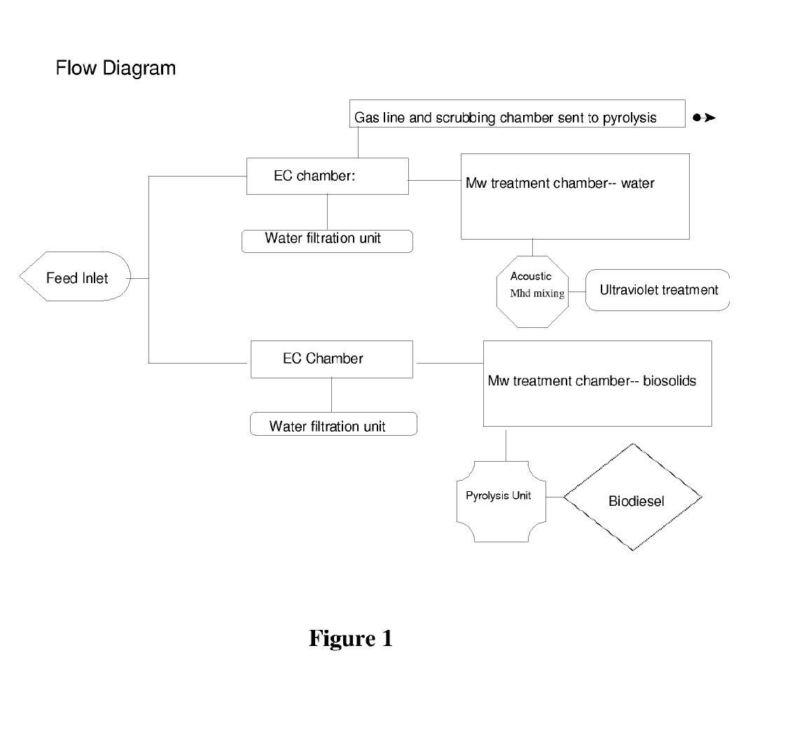

Referring to FIGS. 1-3, non-limiting purposes of the invention are to treat sewage and wastewater (hereinafter “waste”) produced from various sources, including rural, agricultural, livestock operations and municipal wastewater human activities, to eliminate the pathogen content, such as viruses, bacteria, protozoan, and helminthes, to recover a potable water resource, while harvesting energy resources, such as fuel and electrical power. FIG. 1 illustrates a flow diagram of the process according to the present invention. The invention may include a stand alone system that can be scaled up or down, as may be desired. The invention may be portable, packaged, stationary, and/or retrofitted within an existing municipal treatment plant (in combination with existing systems or as an emergency hack up system).

One non-limiting aspect of the invention provides a method, system, and apparatus for harvesting reusable water, energy, and a green hydrocarbon oil from the waste. The hydrocarbon oil may be further processed into a biodiesel fuel that can be used for heating, power generation or transportation fuels. The system may include a combined electromechanical and thermochemical conversion process for harvesting reusable water from the waste. The system may also include microhydrogenerating devices and/or other energy harvesting fibers.

A non-limiting aspect of the present invention provides high-volume treatment of waste in a highly efficient, low energy microwave-acoustical resonance chamber (mw) to rapidly digest solids, provide significant toxicity reduction and harvest water, energy, and low toxicity compost. Secondary energy recovery is possible providing combustible gas and harvesting electricity using advanced composite materials. The conversion process may include (a) electrochemical treatment separation and filtration; (b) microwave assisted digestion and microwave driven thermochemical conversion; (c) ion exchange; and/or (d) thermal acoustic resonance magnetohydrodynamic chamber that thermally heats with turbulent mixing any remaining gray water to remove any additional pathogens and contaminants.

The invention may include a low input power source, such as a portable means for generating energy, which could include, for example, a permanent magnet dc generator, battery, solar, or other renewable source. Suitable low power sources include, but are not limited to, a 12 volt car battery, 24 volt truck battery or a 36 volt battery each with an inverter package. Additionally, solar powered power sources (often preferred in desert climates) may be used, as well as other suitable power sources known to those of skill in the art.

The invention integrates the following technical fields: (1) separation of water, biosolids and various gases from high moisture waste; (2) thermo electrical chemical conversion of the biosolids into a crude biofuel oil; (3) harvesting of water using an electromechanical means; (4) recovery of biofuel oil from volatile solid fraction of the total biosolid content; and (5) sterilization of water with the elimination of pathogens using dielectric heating. Ultraviolet energy treatment may also be utilized to further remove the most persistent of pathogens, such as cryptosporidia whose cyst formations prove impenetrable with ordinary means. Of course, these techniques arc merely exemplary and not to be considered limiting of the invention.

Aspects of the invention provide novel energy harvesting methods. These include, but are not limited to (1) harvesting of heat energy using pyroelectric composite materials (2) harvesting of energy using piezoelectric composite materials to transform mechanical vibration into electrical voltage, and (3) the addition of an acoustic magnetohydrodynamic turbulent mixing resonance chamber to produce electricity directly.

Thus, the objectives of the invention may include intaking high moisture waste and separating out severable usable resources by reducing and recovering each resource through a variety of processes. Resources recovered may include (a) a water resource, which may include H₂O and/or nutrients; (b) a volatile organic biosolid resource, which may include a crude carbon based oil residue; and (c) a gaseous resource, which may include hydrogen gas, methane gas, and/or syngas.

An exemplary apparatus according to non-limiting aspects of the present invention may use chemical, physical and thermo electric conversion processes produced by various means and combined together. Once process may be, for example, a rapid thermal electrical chemical conversion process, such as by using an electrochemical cell, using a pressurized thermal heating or a rapid microwave heating under pressures, such as by using a microwave chamber, and derived using specific balance of carbon monoxide gases and vapors to convert and recover a crude biofuel oil from the volatile organic biosolids separated from the high moisture wastes.

Another process may use electrical energy delivered through iron and aluminum electrodes to recover iron sulfate and aluminum sulfate from the process of electrolysis whereby the hydrogen sulfide, sulfur, phosphate materials within the biosolid fraction of the waste combine with either the iron or aluminum from the electrodes to produce a coagulant or flocking material that assists in separating the biosolid fraction of the waste from the water molecule and aggregates the volatile organics into a humic mass that can be easily converted into a high quality crude biofuel oil. Such process may use a pyrolysis reactor. Electrolytic reactions on the hydrogen sulfide molecule and some percentage of the water molecules release hydrogen gas into the oil (converted from solid) which may then be recovered and scrubbed. To recover and scrub the hydrogen gas, a clinoptilolite or other suitable material may be embedded within the walls of a gas recovery system. The gas recovery system may include a network of iron piping lined with the clinoptilolite material or the like. The clinoptilolite can be combined with additional zeolytic materials. In a non-limiting example, these pipes may be about 26 feet in length, with the dimensions based upon retention time and quantity of gas produced from the process, as desired. The size and length may correspond to expected gas production estimates from quantity of waste input. Clinoptolite is environmentally friendly and absorbs ammonia and sulfur vapors readily. Additionally, it is within the scope of the present invention to include a series of gas recovery chambers configured to harvest specific compounds (e.g., potassium, nitrogen, phosphorus, or lead, and other metals). These structures can be slipped in and out of the system piping like filters.

The gas may be recovered from the system at various points (e.g., before or during electrochemical separation) and may be drawn through a tube and filter combination to prevent the solid particles within the gas from entering into the gas scrubbing system. The gas scrubbing system may include iron pipe lined with these specialty composite materials that selectively absorb unwanted gases and components from the target gases. Additionally the CO, H₂, OH, CH₄ and other gases (preferably once scrubbed) are sent to a converter unit, preferably a pyrolysis reactor (electrothermal chemical reactor) to enrich the crude oil harvested from the biosolid fraction of the waste.

Because it may be desired to recover all usable resources from the waste, the apparatus may be configured to produce additional energy resources using other materials (e.g., pyroelectric or other suitable materials) that enable the harvesting of electricity from the heat energy recovered from the processes that separate the various resource fractions. It is also possible to use materials (e.g., piezoelectric or other suitable materials) that are capable of harvesting electricity from mechanical vibrations derived from the separation of the various resource fractions. (i.e., water, gas, and solid). Generally, pyroelectric materials are also piezoelectric, as they generate charge in response to mechanical strain. They also generate charge in response to heat energy and are useful in transforming the heat of the microwave energy losses from the use of common, inexpensive magnetrons and generate a charge from a similar electrode-substrate application.

According to the present invention, it is also preferable to destroy pathogens in the waste. For example, it may be desired to destroy coliform and E-coli. Destruction of pathogens may be achieved, for example, by the rapid dielectric heating and electro acoustic turbulent multiple standing wave amplification. Cryptosporidia may be used as a metric of pathogen destruction efficiency because the cysts formed arc difficult to destroy by ordinary treatment processes. Also, some acoustic resonance can alter good proteins into prions in the presence of other prions. Ultraviolet treatment may be used to assist in prion destruction. Of course, other suitable methods of destroying pathogens are within the scope of the present invention.

Another exemplary feature of the invention provides a novel method for recovering biofuel oil and/or co-products from the biosolids of the waste within a few minutes of being exposed to digestive heating. For example. exposing the biosolids to controlled low power dielectric heating that rapidly digests the volatile biosolids causes a release of a mixture of biogas including methane gas. It is possible to generate 40% to 65% methane from this process, which is an improvement over anaerobic digestion. Typical municipal waste treatment is not concerned with the harvesting of biogas from non-anaerobic means. Thus this method represents an improvement over municipal wastewater treatment methods currently in use.

Microwave system disinfection of the present invention may be, for example, a steam-based process, since disinfection occurs through the action of moist heat and steam generated by microwave energy. Microwaves are very short waves in the electromagnetic spectrum used to convert high voltage electrical energy into microwave energy. This energy is then transmitted into a metal wave-guide that directs the energy into a specific area (such as the treatment section of a disinfection unit). Microwave technology is an effective disinfection system. The waves of microwave energy cycle rapidly between positive and negative at very high frequency, around 2.45 billion times per second. This causes water and other molecules in the waste to vibrate swiftly as they try to align themselves (like microscopic magnets) to the rapidly shifting electromagnetic field. The intense vibration creates friction, which, in turn, generates heat, turning water into steam. The heat denatures proteins within microbial cells, thereby inactivating pathogens. Without water, however, the lethal effects of microwaves on dry microbial samples are significantly reduced. Thus, the microwave treatment system of the present invention may add water or steam into the waste input stream as part of the treatment process.

Treatment methods of the present invention may also include (1) an equalization primary treatment of (equalization basins, screens and comminutors (mixers, shredders, etc.) grit removal, grease removal and sedimentation. flotation and foaming and sludge pumping and transportation, septic tanks; (2) secondary treatment of activated sludge, trickling filters, aerobic/extended aeration ponds and lagoons, anaerobic digestion, secondary clarification and disinfection; and (3) advanced tertiary treatment of (filtration enhanced by applied chemical coagulants, ultra-filtration membranes), coagulation systems and chemical neutralization and electrolysis, etc.

A non-limiting aspect of the invention includes a reuse water harvesting device that treats waste by separating the liquid fraction from the biosolid fraction utilizing an electrification mechanism in a flow through filtration chamber designed to recover reusable water, hydrogen, biofuel oils and biogas. Hydrogen gas may be separated from the hydrogen sulfide and water content within the waste at electrodes of electrochemical cells of the invention described more below, and may be recovered through a gas membrane attached to the chamber. Drager tubes may be used to measure the gas, e.g. CO-CO2-Hydrogen gas composition. Voltage may be applied to the flow for treatment, such as 110 VAC at 15 amps, which is a constant current. However, other AC voltages, currents, and DC voltages are also within the scope of the present invention. For example, when treating flows greater than two gallons per minute, amperage should be increased. Amperage varies when scaling up of the system to large volumes and process flow parameters. For example, an 18 gal/minute system would require about 240V/60 Amps.

According to non-limiting aspects of the present invention, gases may be released at several locations throughout the process. Gas production is typically related to the volatile biosolids present within the waste. These gases may be separated and scrubbed, and the biogas can be then directly fed into a gas turbine generator.

The waste may be passed into a pressurized spiral filtration mechanism where a peristaltic pump pulls the water through a filter separating a large percentage of water from the solid fraction. The solid fraction is then pushed into a microwave resonance treatment chamber (mw) for processing in which the solids are compressed into an oil or totally digested into an ash product using an adapted thermochemical conversion process where pressure, temperature and gas re-injection occurs (if desired). Any number of microwave resonance chambers may be added to further process the solid fraction. An oil, tar, or low toxicity ash may be recovered (depending on preference). The ash can be used as a fertilizer and if the conditions are adjusted a char can be formed from pyrolysis which occurs before the biosolid is removed of all Hydrocarbon content and the nutrients remain in the charcoal or char remaining. These include Nitrogen, Phosphorus, calcium and other inorganics. There are mercaptans, volatile organic compounds and alkyl esters in manure as well as proteins, animal fat or tallow. The advantages of using the biocrude as an oil is that it can be used as a heating oil or as a fertilizer or as an oil for further processing into chemicals, pharmaceuticals and biofuels as further chemical processing requires per product desired. That allows selection of the resources of greatest value during different seasons of the year like potable water, heat, electricity or transportation fuel.

The water, heated vapor, and any steam may be pumped through a water collection system where it falls and may be aerated through turbulent mixing of the water with paddles. Some electrical energy can be harvested using pyroelectric and piezoelectric composite materials known to convert heat or mechanical motion into electrical current. Additional microhydrogenerating devices, known as pelton wheels or water wheels, may be positioned within the fluid handling system to generate additional electrical current when connected to suitable equipment, such as an alternator and/or a generating device. Electrical energy accumulates from the electrical currents collected from devices throughout the system and may be stored in a suitable storage device, such as a battery.

The invention eliminates pathogens through the combined use of (1) multiple harmonic modalities of targeted electromagnetic radiation (microwave and radio wave frequencies; and (2) the generation of acoustic wave disturbances within the compressible waste water fluid as diffused through the sludge reactor. An ultraviolet light treatment process may also be used as an additional level for eliminating pathogens.

The following description provides a non-limiting description of one embodiment of the invention's system and method as seen in FIGS. 1-3. Initially, inorganic rocks, sand, feathers, etc. are removed from the waste and it is then pumped, such as by using a grinding pump or sludge pump typically used in wastewater treatment, to transport the waste from a storage facility to an inlet iron pipe 10 of the system. The iron pipe is preferably embedded with one or more iron spirals to create a turbulence and mixing effect. Embedded iron spirals can also be added throughout the piping of the system to create turbulence which can be converted to electricity.

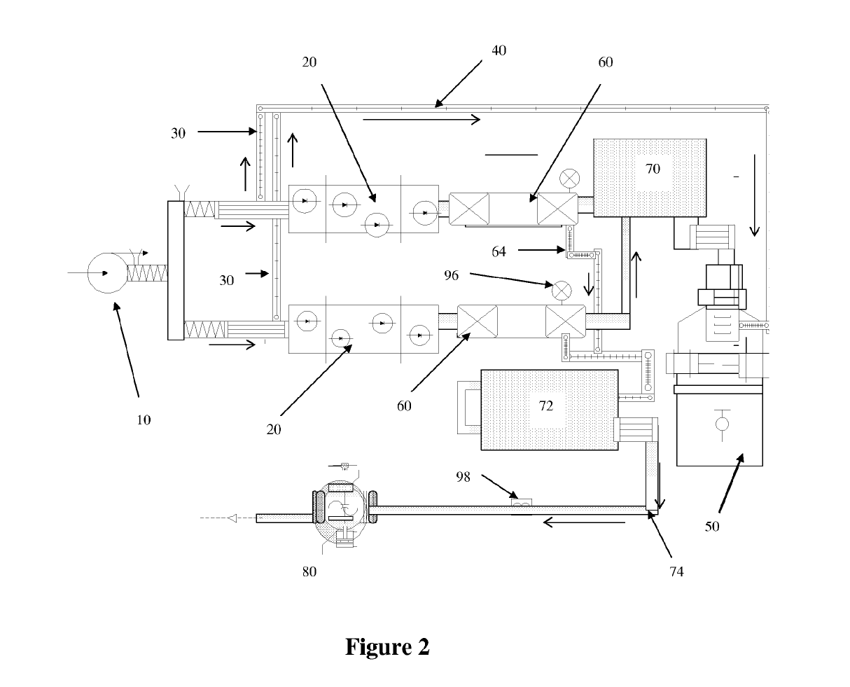

The waste is then directed into an electrochemical cell or cells (EC) 20, as seen in FIG. 2. Each EC chamber has at least one or more pairs of electrodes, preferably made out of iron metal, and includes iron electrodes installed throughout the chamber. The chambers may also be made of other metals, such as stainless steel or aluminum. The electrodes are preferably either 120V/15A or 240V/30A depending upon the size of the chamber. Each EC cell chamber preferably has a cylindrical geometry. The temperatures within the EC cell typically vary from 80 degrees Centigrade to 100 degrees Centigrade or 180 degrees Fahrenheit to 212 degrees Fahrenheit. The temperature is variable as is the waste stream. The waste is rated to travel through the EC chamber based upon the process time. Ion exchange occurs in the EC chambers where the iron from the electrodes exchanges with the Hydrogen sulfide within the water and an iron sulfate is produced and hydrogen is released as a gas. Hydrogen is separated into the H+ and OH. Iron also binds with phosphorus in the water as iron phosphate. Additional iron pipes, elbows and other resistance means may be added to the system as required for the retention time needed for separating the water from the biosolids. The size of pipes connecting the units may be reduced to adjust the flow of the waste stream.

Digestion begins at the time each EC chamber 20 injects electrical energy into the waste. Chemical reactions may occur where Hydrogen sulfide and Ammonia within the waste are separated out of the waste. The Hydrogen Sulfide reacts with the iron to form iron sulfate, and hydrogen gas along with Carbon monoxide and Carbon Dioxide are released into the atmosphere. Gas is removed from the EC chambers 20 using a closed emission system to avoid impeding any electrode activity by substantially preventing gas formation around the electrodes of the chambers. In particular, gas is preferably removed from the system prior to the waste entering the EC chambers 20 via gas lines or pipes 30 (FIG. 2) coupled to the inlet 10 which direct the gas to a scrubber 40. The gas lines may also be coupled to the EC chambers to extract gas directly from the EC chambers. The closed emission system may include an additional filter to remove the gas without the treated water flowing up into the gas line. Also, the iron pipes of the system are preferably lined with adsorbents, such as clinoptolite, granulated high purity carbon or the like as described above. Another area of ion exchange occurs in the gas scrubber where the ammonia and nitrogen compounds are adsorbed into the clinoptolite. The gas is then directed into an inlet port on a conversion unit 50, such as a pyrolysis reactor, to convert the gas into an energy resource, such as biodiesel. The biogas (composed primarily of methane, carbon dioxide, and nitrogen oxide gases) may be directed into a holding chamber until such time as enough pressure and gas builds up to operate a microturbine and/or engine generator apparatus. For example, a significant amount of methane can be recovered with sufficient pressure and LEL (Level of Explosively) to yield a good quality biogas that can be directly fed into a microturbine generator or engine generator.

The waste then leaves the EC chambers and moves through one or more filtration mechanisms 60 (FIG. 2). The filtration mechanisms 60 include filters for separating the waste into water and solid fractions. Although the filtration mechanisms 60 mainly provide for the separation function, separation of the gases and biosolids may be initiated in the EC chambers when the EC discharges current into the chambers. The odor is reduced significantly as these separations occur. One or more pipes direct the solid fraction via vacuum suction into a first microwave reactor 70 while one or more pipes 64 direct the water fraction via a pump to a second microwave reactor 72. Because it generally takes about 146 watts to heat one gallon of water per minute one degree Celsius, it is preferable that the both the water and biosolids enter the downstream microwave components as close to 100° C. as possible to reduce the energy required to further treat the water and solids in the microwave chambers 70 and 72.

Each microwave (mw) resonance chamber 70 and 72 uses microwave energy in a similar manner and both may be similarly constructed with the first microwave chamber 70 receiving the solids fraction of the waste and the second microwave chamber 72 receiving the water fraction of the waste. In the first chamber 70, the solid fraction enters into the microwave resonance chamber where a magnetron assembly and waveguide uses a single magnetron and feeds the microwave energy into a plurality of spiraling inlet ports 44. Wattage input into this first chamber may be about 1200 watts or greater. The microwave chamber accelerates digestion because it has a higher temperature and converts the solid fraction of the waste to mainly oil and/or ash. The microwave chamber may also be constructed with multiple magnetrons installed in series and the microwave cavity extended to include all magnetrons in a large linear design. The oil is then directed to the conversion unit 50 for recovery of fuel, for example crude oil.

In the second microwave resonance chamber 72, the water fraction is pumped through a chamber with a magnetron assembled to a waveguide and directs microwave energy into a plurality of spiraling inlet ports. The bulk of the water fraction is then pumped to a gravity pipe 74 which directs the water fraction to be further sterilized. Water vapor may also be released and condensed through a condenser and aerated in the gravity pipe 74 to further release odorous gases remaining in the water.

As the water fraction continues out of the microwave chamber 72 the temperature preferably increases to 100 degrees Celsius and wattage input may be increased (e.g. to 1200 watts) using a variable control power mechanism. As the water fraction moves through the gravity pipe 74, it is aerated by turbulent mixing of the water, such as by using paddles. Then the water fraction enters a thermal acoustic magnetohydrodynamic resonance chamber 80 for harvesting electrical energy and eliminating any remaining pathogens, such as those that are known to resist microwave heating. The thermal acoustic resonator is a spherical chamber in which the remaining water fraction is rapidly mixed and agitated using acoustic energy combined with magnetohydrodynamic (mhd) turbulent mixing which eliminate any remaining pathogens. It is here that heat is developed from the turbulent mixing of the processed water as multiple standing waves are generated within the dual walled ceramic chamber 82 using a composite transducer 84. Improved operating efficiencies may be achieved by selecting a suitable ceramic composite. The dual walled chamber maximizes acoustic resonance producing multiple standing waves. A piezoelectric ceramic is preferably used to ensure satisfactory functioning of the repeating echo sounder. Other ceramics may be used, such as perouskite ceramics with magnetic, pyroelectric or piezoelectric properties. Magnets 86 or other suitable energy confinement devices may be embedded within the ceramic outer wall to confine the energy. Aerogel or other suitable insulation material 88 may be inserted within the void space between the two walls to contain the heat, so that the pyroelectric and piezoelectric fibers embedded within the system ceramic walls can harvest additional energy thereby transforming the heat energy into electrical voltage and the mechanical energy from the multiple standing waves into voltage. A motor 90 and impeller blades 91 assist in mixing the water. At this point, the water no longer has an odor as the chemical reactions separate the volatile organic compounds into various products.

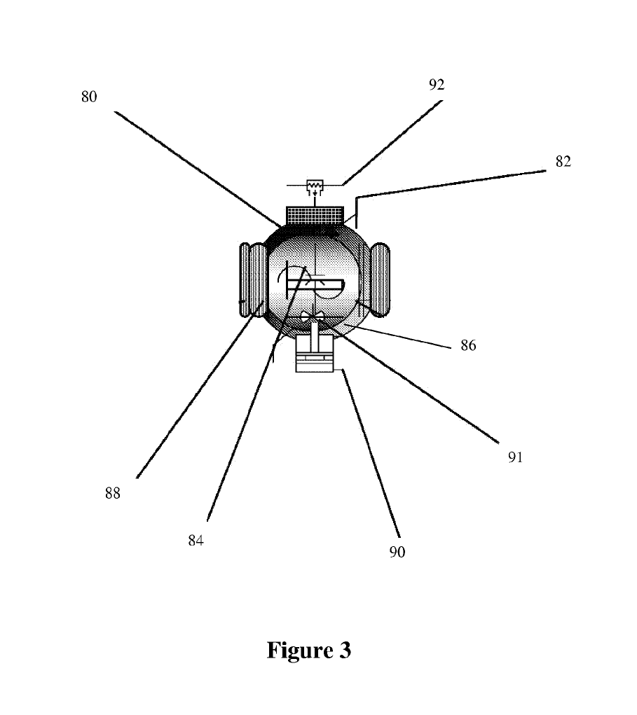

FIG. 3 illustrates a non-limiting example of the thermal acoustic magnetohydrodynamic resonator 80 of the present invention. The chamber of the resonator may have a spherical geometry and may be rotated counterclockwise using a suitable rotation mechanism 92. The rotation mechanism may be located above the chamber of the resonator. A cubic core-magnetron assembly is differentially rotated by a north polar motor assembly connection; and, that the 1^{st} and 2^{nd} outer rigid mantle boundary chambers are connected independently to a south polar motor assembly; and the core rotates one direction and the outer chambers rotate counterclockwise. As there may rarely be a perfect match between the microwave frequency used and the resonant frequency of the load, it may be helpful to reconfigure the transducer installation to maximize the effect of multiple generated standing waves. It is further embodied within the invention that the cubic core ceramic comprises one “MHD-electrode” of a pair and that the first outer rigid mantle boundary mantle spherically surrounding the wastewater liquid core chamber comprises the second “MHD electrode” and that both comprise the electrode pair.

The composite transducer 84 of the present invention functions as a transmitter, radiating sound within the spherical chamber resonator. The diameter of the radiation area of the transducer may be isotropic to direct multiple standing waves throughout the chamber, thereby disrupting and agitating the water prior to release into water storage. This enables creation of a thermal acoustic energy within the chamber. The turbulent mixing within this spherical reactor 80 with the multiple standing waves and the formation of violent convection cells demonstrates effectiveness in disrupting bonds of corrupted proteins, prionic materials, and resistant pathogens that microwave energy alone may not be able to accomplish.

The now pathogen free water may be piped into a secondary filtration system configured to remove additional contaminants and/or organics remaining in the water. For example, the filtration system may include a reverse osmosis filtration apparatus or other suitable filtration system to remove such contaminants. Ultraviolet energy may also be applied. The water is then available for potable use. Before storing the water, it may be optionally fed through a micro-turbine to generate additional potential energy to the energy storage. For example, an additional hydro-turbine may be used to generate energy for battery storage.

Pressure sensors 96 and flow rate gauges 98 of the system are represented in FIG. 2 and may be placed throughout the system, as desired. Also, it is preferable that the system uses a pump that is timed to the retention process time required that feeds the waste into the system and a second pump that pulls the waste through the chambers. Additional pumps may be added throughout the system where required. Also piezoelectric material composites may be used throughout the system wherever mechanical vibrations are found within the system process, for example the turbulence of the water as it passes through the pipes. And the pyroelectric composite materials may be used wherever heat can be removed from the system, as for example during microwave heating where losses and waste heat are generated within the system processes.

The following description addresses an experimental embodiment according to non-limiting aspects of the present invention.

Overall Assembly

Weight (lbs.): 285 (500 lbs for a large system);

Assembly Dimensions (L×W×H in inches): 46×46×27 (9 ft by 6 ft by 4 ft for a large system); and

Process treatment volume: 60 mL /m and 600 mL/h @5 processes=30 L (preferably the process flow is 1.5 galloons per minute and processes 1000 gallons per day).

Equipment Orientation:

Package laboratory test unit with interchangeable components:

(1) Two solids reactors, (2) two water purification reactors; (3) three electrochemical cells, (4) separation/filtration advanced composite materials, (5) pumps and fluid handling equipment including additional piping and resistance using elbows, turns, and spirals to enable process flow retention time; (6) gas handling and scrubbing equipment; and (7) electrical system.

Mounting Strategy (Bolts/Studs or Straps):

Set chambers and piping onto rolling trolley with three levels.

Power Requirement (Voltage and Current Required):

Power Supply 1: 120 Volts and 30 Amps per electrochemical cell (large system requires 240 Volts and 60 Amps per electrochemical cell;

Power Supply 2: 12 V DC battery pack with 2500 watt inverter (for large systems, preferable use a tractor driven generator which is capable of 240V and 70 Amp capacity); and

Power Supply 3: 5 kW portable generator

Initial studies were conducted on the formation of bubbles, convection cells and floc formation using manure waste under various conditions to determine potential to recover reusable water and separate the TDS (total dissolved solids) and TSS (total suspended solids) from the initial waste. The characteristics of the waste were studies, its biogas evolution and gas speciation (ammonia, hydrogen sulfide, methane, balance gases (VOC, NOx, SOx, HC, particulate, etc) to understand the way these gases related to one another.

The potential for energy harvesting from heat, mechanical energy and other sources, which included the recovery of biogas, a thermally converted fuel oil and a final reduction in mass with the digestion of the biosolid fraction to a neutral ash within a flow through continuous but pressured system were studied, The chemical energy stored within the waste was evaluated and alternative ways to convert this chemical potential into energy generation were discovered.

Also, highly conductive properties were established and gas evolution properties were mapped. The gas evolution is as follows:

Thermal=HS→NH3→H2O vapor→CO2-CH4-CO NOx+SOx+VOC

Microwave=HS→NH3→H2O vapor→CO2-CH4-CO+NOx+SOx+VOC

Electrochemistry=H↑+OH+HS+VOC+CH4+NOx+SOx+water vapor

Criteria was established for including microhydrogenerating devices, solar hot water and photovoltaic technologies. It was discovered that the waste could be manipulated using thermal, microwave, electrochemistry, ultrasonic treatment.

The following milestones were achieved during experimentation:
1. Determined potential to recover reuse water
2. Determined potential to harvest energy
3. Pathogen destruction rate efficiencies established and achieved: Coliform and E. coli
4. Potential to recover reuse waste gas as a fuel source in different Phases
5. Discovered biosolids can be further treated and converted into a combustible oily residue, or tar or ash, as desired.
6. Designed, constructed, and tested several prototypes

TABLE 1

| Research | | |
|---|---|---|
| Component | Testing Method | Achievements |
| Reactor material | Select composite | Adapted materials: |
| development | materials to meet | Gas scrubbing |
| | appropriate dielectrics, | Mw-standing waves |
| | resonance & | Water/solids |
| | performance criteria | separation |
| Establish the Data | Design the computer | Determined data points - |
| Analysis | integration method to | on/off switch |
| Method for lab | test for dimensions of | Dimensional analysis - |
| tests | system process: | pressure, temperature, |
| | pressure, temperature, | flow rates, velocity |
| | flow rates, gas recovery, | |
| | etc. | |
| Water production | States of water: vapor or | Sufficient purified |
| quantify and | liquid; quantify | water was recovered |
| determine quality | pathogens | and test confirmed |
| to meet | | elimination of most |
| standard | | pathogens including E. coli |
| | | and coliform. |
| | | Water quantity |
| | | represented 70-90% of |
| | | manure feedstock |
| | | processed |
| Pathogen | Determine frequency of | Established destruction |
| Destruction | inactivation, microwave, | efficiency rates |
| Efficiency | ultraviolet, quantify | coliform and E. coli - |
| DRE rates | species | time duration of |
| | | treatment |
| Induced Fields | Lab test facilities using | Microwave studies |
| generated both | selected materials based | determined the power i [symbol] |
| electric and | upon dielectrics, mw- | watts required and proce [symbol] |
| magnetic field | mhd coupling | times, field strengths an [symbol] |
| strengths, | requirements, computer | cavity designs required [symbol] |
| characterization, | model | achieve biocrude oil |
| quantities, | | production. |
| shielding | | Pathogen destruction |
| necessary | | efficiency rates using |
| | | dielectric heating also |
| | | established |

[symbol]

indicates data missing or illegible when filed

An additional reaction chamber was included within this device. This is the acoustic magnetohydrodynamic mixing reaction chamber. It is here that heat may be developed from the turbulent mixing of the wastewater whereby multiple standing waves arc generated within the dual walled ceramic chamber using a composite transducer. Magnets may be embedded within the ceramic outer wall to confine the energy. Of course, other suitable configurations are within the scope of the invention.

An aerogel insulation material was inserted within a void space between the two walls at the reaction chamber to contain the heat so that the pyroelectric and piezoelectric fibers embedded within the system ceramic walls can harvest additional energy by transforming the heat energy into electrical voltage and the mechanical energy from the multiple standing waves into voltage.

The acoustic resonance chamber also included a ceramic composite. The mechanical quality factor Qₘₒ (no load condition) of composite transducers may be higher than that of single piece transducers. The equation below explains the overall electro-acoustic efficiency:

η_{maz}−1−2/κ_{eff}√Q_{E}Qₘ₀(κ_{eff}√Q_{E}Qₘ₀)

The composite transducer acts as a transmitter radiating sound within the spherical chamber of this embodiment. The diameter of the radiation area is isotropic and the design is to direct multiple standing waves throughout the chamber to disrupt and agitate the water prior to release into water storage. Of course, other suitable transducers are within the scope of the present invention. Thus, it is possible to create a thermal acoustic energy within the chamber. The turbulent mixing within the reactor with the multiple standing waves and the formation of violent convection cells disrupts the bonds of corrupted proteins. prionic materials and resistant pathogens that microwave energy alone is often not able to accomplish.

As the acoustic resonance reactor chamber is sealed shut, the differential rotational motion may be generated via external motor sources outside the reactor but individually connected each to one of the two polar connections (e.g., north and south). Thus, a velocity field may be generated and angular momentum creates a strong vorticity, causing generation of a secondary magnetic field. The generation of an acoustic wave may be achieved using any suitable equipment within the chamber. It may be desirable to account for a programmable spherical harmonic relationship to the compressible fluid.

At this point, the pathogen free waste is piped into a secondary filtration mechanism. For example, a reverse osmosis system may be used as the filtration mechanism, which enables removal of additional contaminants or organics that may be present as discussed above. The water is then available for potable use and the water may be stored in any suitable storage container.

While particular embodiments have been chosen to illustrate the invention, it will be understood by those skilled in the art that various changes and modifications can be made therein without departing from the scope of the invention as defined in the appended claims.

For example, the present invention may be configured to treat water from both point sources and non-point sources. Aspects of the present invention may include primary, secondary, and tertiary means to treat the wastewater and recover water. Also, a hybrid generator may be used that combines a method of destroying pathogens and a means of modifying various field strengths, modalities, harmonics, and frequencies generated. The generator may also include mechanisms for filtration, crushing, mixing, or shredding of waste waters of varying compositions and sewage to present the influent in a homogenous raw slurry prior to treatment within the hybrid acoustic resonance chamber.

What is claimed is:

1. A method for harvesting potable water and energy from waste, comprising the steps of:
collecting the waste;
separating the waste into a water fraction, a solid fraction, and a gas fraction;
sterilizing the water fraction;
converting the solid fraction into an energy resource; and
scrubbing the gas fraction.

2. A method according to claim 1, further comprising the step of:
converting the gas fraction into an enegery resource.

3. A method according to claim 1, further comprising the step of:
converting the water fraction into an energy resource.

4. A method according to claim 3, wherein
converting the water fraction into an energy resource includes producing electricity using an acoustic resonance reactor.

5. A method according to claim 1, further comprising the step of:
electrochemically treating the waste prior to separating the waste into the water and solid fractions.

6. A method according to claim 1, further comprising the step of:
applying microwave treatment to one of the water fraction or solid fraction of the waste after the waste is separated into the water, solid, and gas fractions.

7. A method according to claim 1, wherein
converting the solid fraction of the waste includes the step of thermochemically converting the solid fraction to oil.

8. A method according to claim 1, further comprising the step of:
harvesting energy from the gas and solid fractions of the waste by using pyroelectrie or piezoelectric materials.

9. A system fhr harvesting potable water and energy from waste, comprising of:
an inlet for collecting the waste;
at least one electrochemical chamber coupled to said inlet that receives the waste and is adapted to treat the waste in a first phase of digestion;
a filtration device coupled to said electrochemical chamber that receives the waste and includes a least one filter for separating the waste into at least a water fraction and a solid fraction;
at least one microwave chamber coupled to said filtration device that receives at least one of the water fraction or the solid fraction of the waste and is adapted to treat the waste in a second phase of digestion; and
a conversion unit coupled to said microwave chamber that receives said one of the water fraction or solid fraction of the waste and is configured to harvest at least one energy resource therefrom.

10. A system according to claim 9, further comprising
a gas line coupled to said inlet and configured to extract and scrub a gas fraction from the waste, said gas line being coupled to said converstion unit for harvesting at least one energy resource from the gas fraction of the waste.

11. A system according to claim 10, wherein
the at least one engery resource from the gas fraction is one of hydrocarbon or methane.

12. A system according to claim 9, further comprising
a second mirowave chamber coupled to said filtration device that receives the other of the water and solid fractions of the waste for treatment thereof.

13. A system according to claim 9, wherein
said converstion unit is a pyrolysis reactor that receives the solid fraction of the waste from the microwave chamber.

14. A system according to claim 9, wherein
the energy resource harvested from the solid fraction is at least biofuel.

15. A system according to claim 9, wherein
said conversion unit is an acoustic resonance chamber that receives the water fraction of the waste for harvesting an energy resource.

16. A system according to claim 15, wherein
the energy resource harvested from the water fraction is at least electricity.

17. A system according to claim 15, wherein
said acoustic resonance hamber is a spherical thermal acoustic ceramic chamber having a transducer housed therein for producing multiple standing waves.

18. A system according to claim 9, wherein
said inlet, electrochemical chamber, microwave chamber and converstion unit being coupled via piping.

19. A system according to claim 18, wherein
said piping includes spirals on the inside thereof for creating turbulence in the waste.

20. A system according to claim 18, wherein
said piping being lined with a gas absorbing material.

21. A system according to claim 9, further comprising
a battery coupled to the conversion unit for storing energy.

22. A system according to claim 9, further comprising
a secondary filtration device coupled to said conversion unit for further sterilizing the water fraction of the waste.

23. A system according to claim 22, further comprising
said secondary filtration device uses one of reverse osmosis and ultraviolet energy.

24. A system for harvesting potable water and energy from waste, the system comprising of
a means for collecting the waste;
a means for separating at least a water fraction and a solid fraction from the waste, said means for separting being downstream of said means for collecting waste;
a means for harvesting fuel from the solid fraction of the waste, said means for harvesting fuel being downstream of said means for separating; and
a means for sterilizing the water fraction of the waste, said means for sterilizing being downstream of said means for separating.

25. A system according to claim 24, further comprising of:
a means for separating a gas fraction from the waste, said means for separating the gas fraction being couled to said means for collecting.

26. A system according to claim 25, further comprising of:
a means for converting the gas fraction of the waste into fuel.

27. A system according to claim 26, wherein
the fuel being hydrocarbon or methane.

28. A system according to claim 24, wherein
the fuel being biodiesel.

29. A system according to claim 24, further comprising of:
a means for converting the water fraction of the water into an energy resource, said means for converting the water fraction being downstream of the means for separating the waste.

30. A system according to claim 29, wherein
the energy resource is electricity.

31. A system according to claim 24, further comprising of:
a means for storing energy coupled to at least one of said means for harvesting fuel and said means for sterilizing the water fraction.
